(19) United States
(12) Patent Application Publication
(10) Pub. No.: US 2007/0236496 A1
(43) Pub. Date: Oct. 11, 2007

(54) Graphic arts image production process using computer tomography

(76) Inventors: Charles Keller, San Antontio, TX (US); Ali N. Bahadur, San Antonio, TX (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/732,538

(22) Filed: Apr. 4, 2007

Related U.S. Application Data
(60) Provisional application No. 60/789,968, filed on Apr. 6, 2006.

(51) Int. Cl. G06T 17/00

(52) U.S. Cl. 345/424

(57) ABSTRACT

A graphic arts image development process includes the generation of a computer tomography scan of an object to yield a computer data file representative of a three-dimensional volume X-ray density of the object. Computer algorithms operate on the computer data file to yield an object rendering as a three-dimensional array of false color pixels. A graphic arts technique is applied to the object rendering within a two-dimensional image space to yield the graphic arts image. Graphic art image techniques applied to the object rendering include duplication, symmetry inversion, contrast inversion, superposition, or distortion. Superposition is of a second image where the second image is provided by conventional imaging techniques or is a rendering of a second object produced by computer tomography scanning. A graphic arts image development process is also provided that includes generation of a computer tomography scan of an object to yield a computer data file representative of a three-dimensional volume X-ray density of the object. Computer algorithms operate on the computer data file to yield an object rendering as a three-dimensional array of pixels. By associating the number of computer data file data points less than the total number of data points together, a grouping movable relative to the remaining data points is obtained thereby facilitating animating a motion of a grouping of data points. The animation is provided to animate a shell of data points over a three-dimensional volume of data points.

### CROSS-REFERENCE TO RELATED APPLICATIONS

This application claims priority of U.S. Provisional Patent Application Ser. No. 60/789,968 filed Apr. 6, 2006, which is incorporated herein by reference.

### FIELD OF THE INVENTION

The present invention relates in general to a process for generating graphic arts images and in particular to object tomographic scanning to generate a base image.

### BACKGROUND OF THE INVENTION

Computer tomography (CT) scanning permits nondestructive inspection of interior structures of an object at submicron resolutions. A computer data file is generated from these CT scans corresponding to electron density values for the three-dimensional spatial region scanned inclusive of the object. The resulting computer data files are routinely manipulated in the context of medical and scientific applications to view cross-sectional images, as well as the three-dimensional extent of interior structures.

Currently, providing imagery of interior structures of an object for educational, commercial, or artistic purposes requires a highly skilled graphic artist capable of conceptualizing and accurately rendering an image. In preparing such images, the graphic artist must sacrifice visual clarity in attempting to render outer layers as a ghost image or alternatively depict retraction instruments or otherwise show a partial cutaway of an outer layer. While these conventions are visually understandable when depicting a single sublayer, attempting to depict multiple sublayers and/or structures becomes visually so complex as to be a tractable project for only a handful of skilled illustrators.

Thus, there exists a need for the implementation of computer tomography to generate base images for subsequent graphic artistry modification to generate advertising, commercial and artistic renderings.

### SUMMARY OF THE INVENTION

A graphic arts image development process includes the generation of a computer tomography scan of an object to yield a computer data file representative of a three-dimensional volume X-ray density of the object. The scan is collected from an object that is temporally unchanged or dynamic. Computer algorithms operate on the computer data file to yield an object rendering as a three-dimensional array of false color pixels. A graphic arts technique is applied to the object rendering within a two-dimensional image space to yield the graphic arts image. Graphic art image techniques applied to the object rendering include duplication, symmetry inversion, contrast inversion, superposition, or distortion. Superposition is of a second image where the second image is provided by conventional imaging techniques or is a rendering of a second object produced by computer tomography scanning.

A graphic arts image development process is also provided that includes generation of a computer tomography scan of an object to yield a computer data file representative of a three-dimensional volume X-ray density of the object. Computer algorithms operate on the computer data file to yield an object rendering as a three-dimensional array of pixels. By associating the number of computer data file data points less than the total number of data points together, a grouping movable relative to the remaining data points is obtained thereby facilitating animating a motion of a grouping of data points. The animation is provided to animate a shell of data points over a three-dimensional volume of data points.

### BRIEF DESCRIPTION OF THE DRAWINGS

The present invention is further detailed with respect to the accompanying drawings. These drawings depict illustrative embodiments of the present invention and are not intended to limit the scope thereof. This application contains at least one photograph executed in color. A set of three (3) color photographs and one (1) black and white photograph are provided pursuant to the provisions set forth in 37 CFR 1.84(b)(2).

FIG. 1 is a two-dimensional isosurface rendering of an acorn from a three-dimensional CT data set;

FIG. 2 is a two-dimensional maximum electronic density projection of the acorn depicted in FIG. 1;

FIG. 3 is a one-dimensional transfer function rendering of the acorn depicted in FIG. 1;

FIG. 4 is a two-dimensional transfer function rendering of the acorn depicted in FIG. 1;

FIG. 5 is orthogonal cross sections of the acorn depicted in FIG. 1;

FIG. 6 is a two-dimensional graphic image of a flower generated from a three-dimensional CT data set and rendered with a binary threshold filter applied; and

FIG. 7 is a two-dimensional graphic image of the flower of FIG. 6 rendered in negative and superimposed in a spirally distorted two-dimensional image of a seahorse derived from a three-dimensional CT data set;

FIG. 8 is a two-dimensional graphical image of a plum from a three-dimensional CT scan data set including a perspective wedged view and three orthogonal cross-sectional views as a unitary panel;

FIG. 9 is a two-dimensional graphical image of a transversely cut orange rendered from a three-dimensional CT scan data set in four different color schemes and arranged quadrangularly;

FIG. 10 is an artificial color two-dimensional graphic image of a fish from a three-dimensional CT scan data set accentuating the skeletal structure; and

FIG. 11 is a two-dimensional graphic image of a crayfish generated from a three-dimensional CT data set.

### DETAILED DESCRIPTION OF THE PREFERRED EMBODIMENTS

The present invention has utility as a method of generating graphic arts images for mas media artistic, advertising, engineering simulation, animation, and commercial purposes.

As used herein, an “object” is defined to include any substance amenable to nondestructive inspection by inspected by millimeter, sub-micrometer, or sub-micrometer scale resolution computer tomography and specifically includes invertebrate animals, plants, inanimate natural structures, and manmade substances.

Computed tomography permits non-destructive inspection of the inner structure of objects with micron-scale detail. Using X-rays to take multiple two-dimensional pictures of an object at different angles, computed tomography generates a three-dimensional virtual reconstruction data set of the original object that can be viewed at variable levels transparency. Conventional computer science tools then enhance surface properties or can create a transparency of the entire object. Computer algorithms also serve to enhance inner features based on not only their density but also their curvature and edge sharpness. The resulting graphic image is amenable to transfer to a printing machine to produce image reproductions by various conventional printing techniques to mass produce images. With techniques such as lithography and off-set printing, high quality runs of 10, 100, or even more than 10,000 are readily produced of two dimensional prints or three dimensional copies.

X-ray computed tomography can be performed on a microscopic or a clinical CT scanner to accommodate the size of the object and the resolution required for the artistic rendering. These scans generate successive two-dimensional projections at varying angles around the object of interest yield three-dimensional holograms and anaglyphs.

Reconstruction of the two-dimensional projections into a three-dimensional data set requires back-projection, generally using a Feldkamp algorithm (1). Another reconstruction technique operative herein is an algebraic reconstruction.

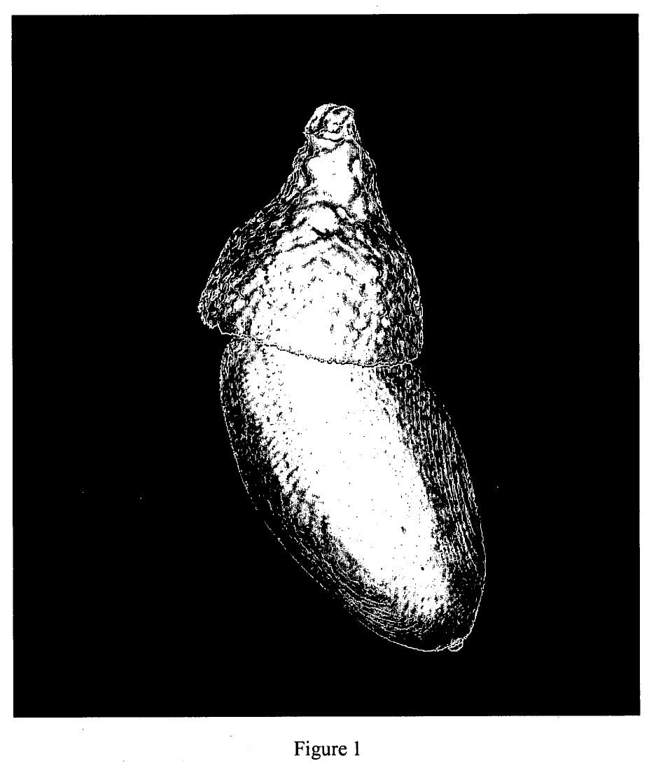

For rendering of isosurface, a method called matching cubes based on a single generic rule capable of generating triangulated isosurface for all predefined cube configurations is used (2). An example of an isosurface rendering of an acorn is shown in FIG. 1.

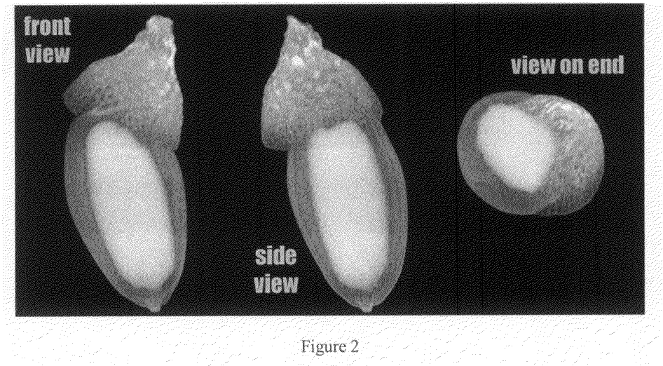

For generation of maximum intensity projections (MIP), the viewing rays are outlined from the operator to the display screen with the object in between, and only the relative maximum value detected along each ray path is employed to produce the image (3). An example of an MIP rendering of an acorn is shown in FIG. 2.

For rendering of density and/or boundary properties using one-dimensional and two-dimensional transfer functions, the volume renderings are computed with a standard brute-force ray-casting algorithm, using the framework presented by Levoy (4), which proceeds as follows: for each pixel in the rendering, a geometric ray is cast through the CT volume according to the virtual camera position, and the CT values and gradient vectors are densely sampled along the rays. The gradient vectors are the basis of the synthetic shading which conveys local surface orientation. The value and gradient measurements are performed by convolving the discrete CT volume samples with separable continuous kernels, as described by Moller et al. (5), using the Catmull-Rom kernel for value measurement, and the derivative of the uniform cubic B-spline for derivative measurement. Other than early ray termination after hitting a nearly completely opaque region, no optimizations or approximations are employed, resulting in a highly accurate, though computationally intensive, rendering. The computation for each horizontal row of pixels can be performed on a single computer or by distributive processing.

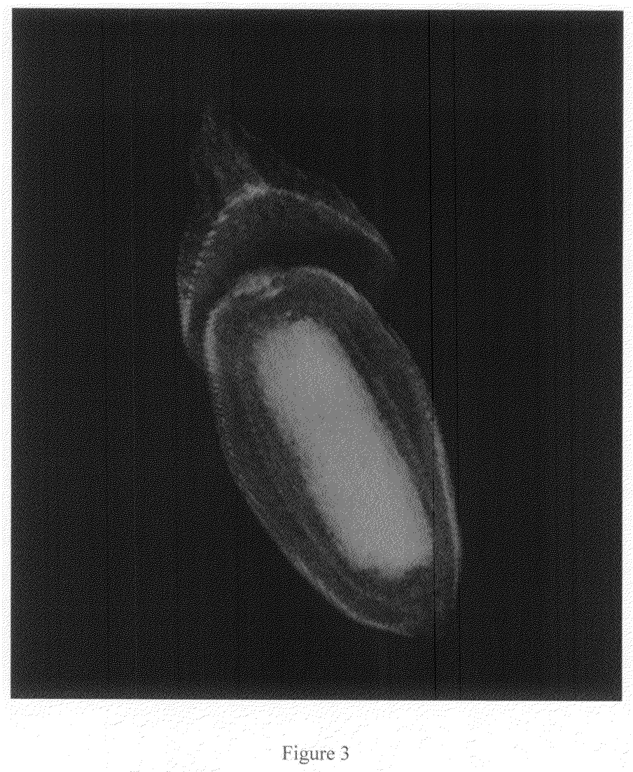

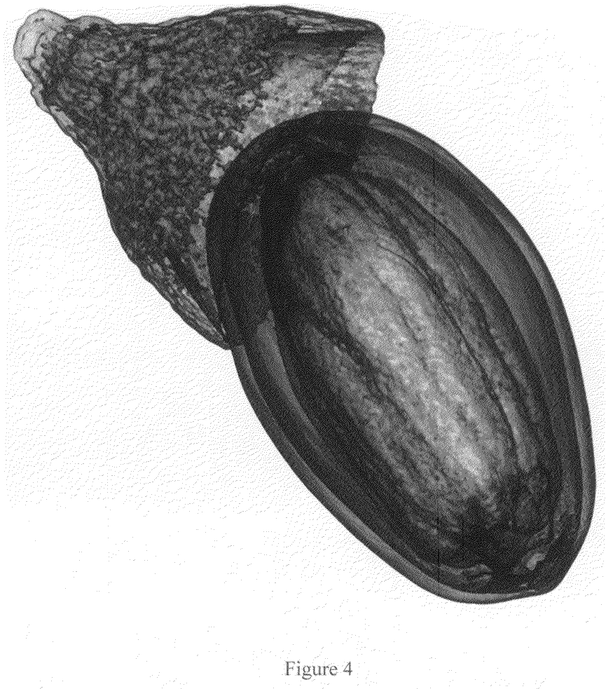

Colors and opacities are assigned to the ray sample according to the transfer function, which is parameterized by either CT value (in the case of one-dimensional transfer functions), or both CT value (synonymously described as a density value) and gradient magnitude (in the case of two-dimensional transfer functions). Transfer functions are manually adjusted based on guidance provided by CT value histograms. An example of a one-dimensional transfer function rendering of an acorn is shown in FIG. 3. For two-dimensional transfer functions, the transfer functions are created with guidance from a joint histogram of CT value and gradient magnitude, based on the considerations outlined by Kindlmann and Durkin (6). An example of a two-dimensional transfer function rendering of an acorn is shown in FIG. 4.

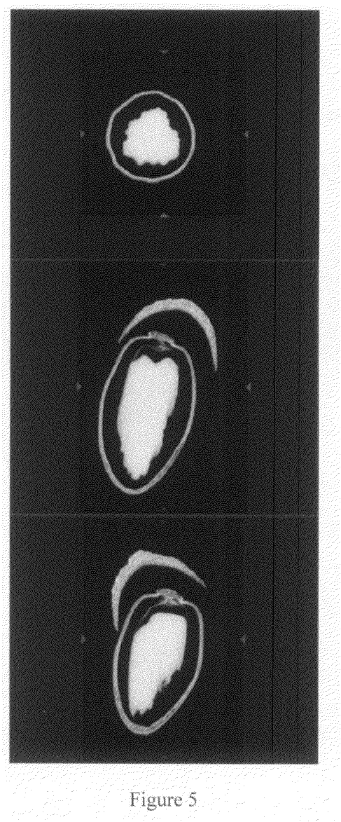

For renderings of orthogonal sections of a scanned object, the plane of section is simply selected and the density values displayed, with or without pseudo-coloring. Examples of orthogonal slice renderings of an acorn are shown in FIG. 5.

Disclosed are the algorithms and techniques used to prepare the inventive graphics base data set as well as the techniques for subsequent graphics manipulation. It is understood that when combinations, subsets, interactions, groups, etc. of these techniques are also operative herein, even though specific reference to each various individual and collective combination and permutation of these scanning and rendering techniques is not explicitly disclosed; each is specifically contemplated and described herein. For example, if phase contrast computed tomography is used instead of standard computed tomography, or if three-dimensional transfer functions are used instead of one- or two-dimensional transfer functions.

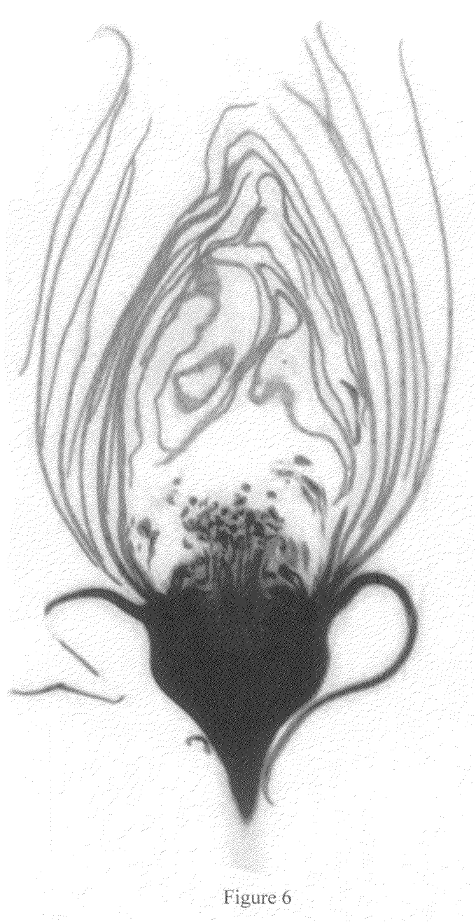

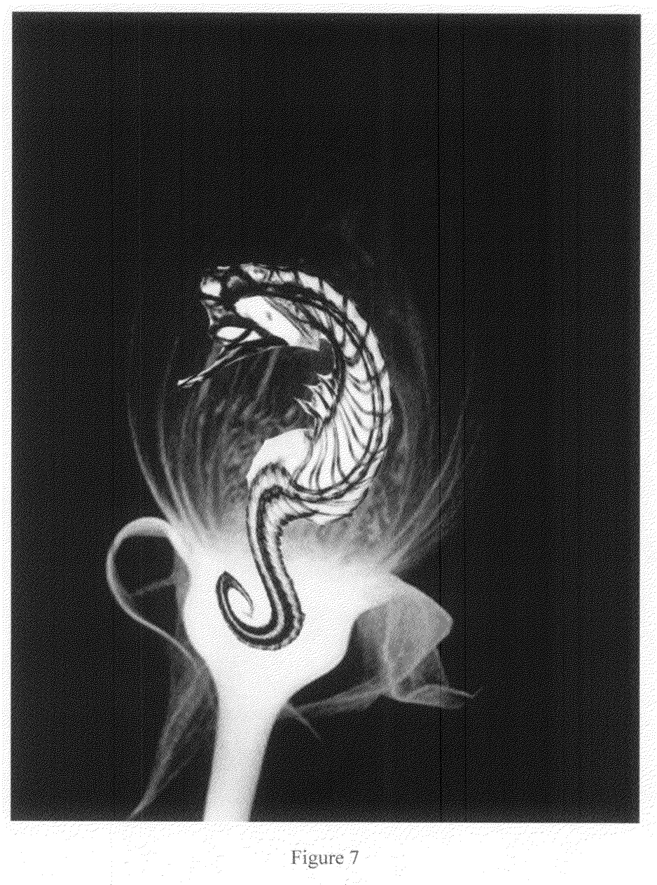

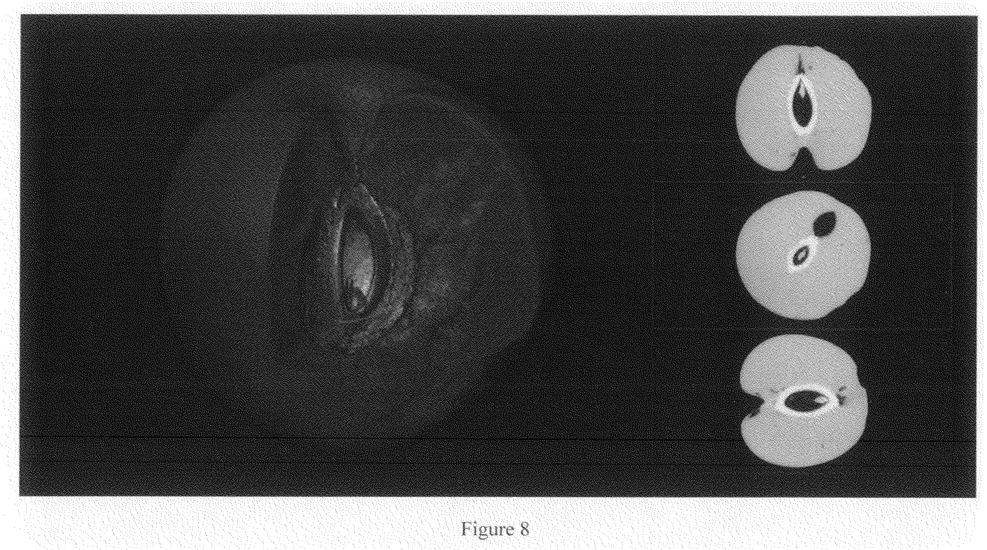

The resulting CT renderings produced by applying various computational algorithms to the CT scan computer data file are then modified to provide visual effects in a graphic art context that have previously been unavailable. Application of graphic arts techniques include copying a given image data file to provide an array of like object images, placing a rendering in juxtaposition to a symmetry inverse of the rendering to form a bookend image, placing a rendering in juxtaposition with an inverted contrast version of the rendering, superimposing on the rendering of another image for rendering independent of visual content of the superimposed image, and visually distorting the rendering. An exemplary two-dimensional (2D) image from a three-dimensional CT scan data file to which a binary filter has been applied is shown in FIG. 6. An image is readily superimposed over a first image and as shown in FIG. 7, the image is a spatially distorted CT generated image of a seahorse. The proximal association of different views of an object also provides a depth of internal detail unavailable prior to the present invention, as shown in FIG. 8 for a plum having an internal void. It is appreciated that each of the aforementioned rendering modification techniques to afford an inventive graphical image that occurs with color modification to a particular rendering or portion of a rendering. The graphical image existing as a data file corresponding to the X-ray density of the three-dimensional object to which individual points are assigned arbitrary false color, manipulated as to position, or relative motion compared to the initially collected data points. In another example, the pixels of a rendering or portion of the rendering have the interpixel spacing modified to provide visual effects of the rendering object expanding, contracting and modulating about an arbitrary origin. Functions are well known for modifying interpixel spacing and illustratively include Bessel functions, Fourier and Laplacian transforms.

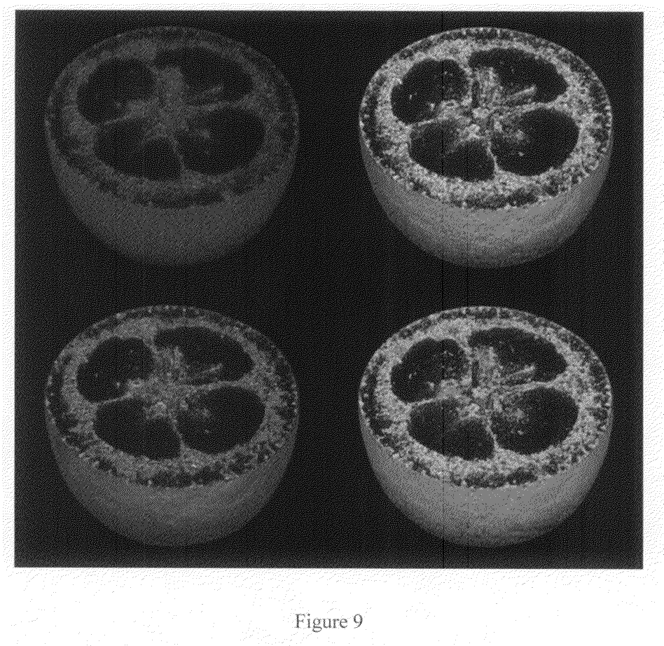

As shown in FIG. 9, a three-dimensional micro CT data set is projected as a two-dimensional graphic image of a cut orange with a first set of false colors as depicted at the upper right. The rendering is replicated with varying colors to form a quadrangular panel of four images providing a desired visual effect.

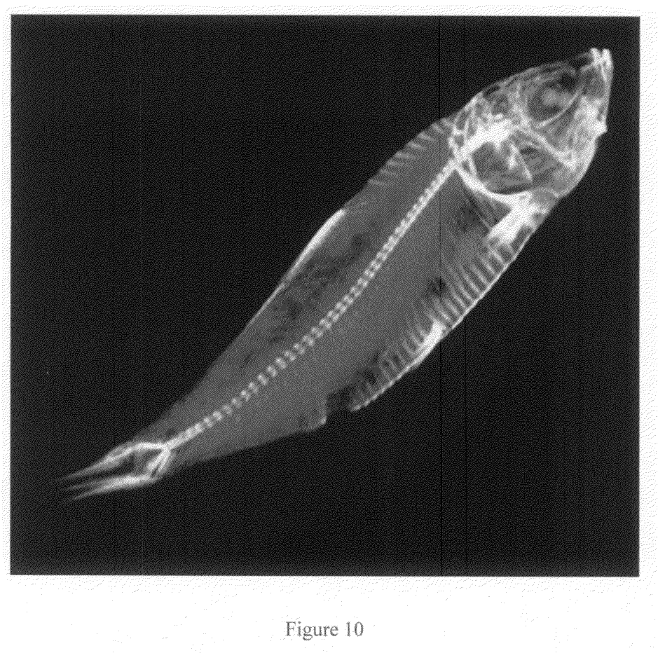

A three-dimensional micro CT data set is optionally filtered to enhance visually a particular layer or structure that in FIG. 10 is the skeleton of a fish. Since the image exists as a three-dimensional array of data points, any one point is separately modified or multiple points joined to facilitate generation of an animated image. By way of example by joining data points corresponding to the vertebrae and propagating a time-dependent wave function along the vertebrae, an illusion of a swimming skeleton is provided.

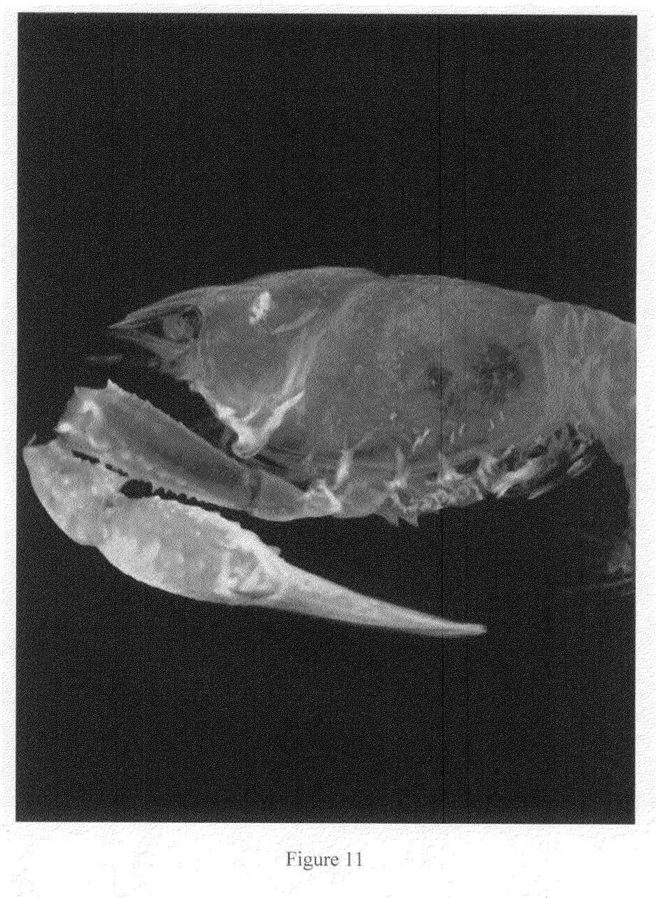

Likewise a crayfish three-dimensional CT data set while amenable to two-dimensional rendering of FIG. 11 is also used in whole or part to create a basis for an animated figure displayed alone or blue-screen superimposed with line action images to create a realistic special effect with less effort than currently required and easily affords imagery of internal structure beyond the wire-frame imagery currently utilized in the animation arts.

In addition to static graphic media such as print, it is appreciated that the present invention also has applications in the production of animated graphic arts images. Animated graphics are appreciated to find uses in generating films, structural simulations, video games, three-dimensional laser scan prototyping, holograms, and anaglyphs. It is appreciated that a hologram is produced by mapping angularly shifted versions of an array of wire-frame shell or interior volume pixels onto a two-dimensional holographic substrate to give a perception of depth.

Upon generating a computer tomography scan of an object to yield a computer data file representative of a three-dimensional volume X-ray density of the object, and performing computer algorithms on the computer data file as detailed above to yield an object rendering as an array of pixels, a group of data points are arbitrarily selected from within the data file and grouped to form a grouping relative to the remaining data points. In this way animated motion of the grouping occurs. It is appreciated that an overlying texture, another false color or combination thereof are readily applied to the rendering. In forming multiple groupings by associating data points, each group so defined is readily movable relative to other groups. The net effect of data point association and grouping is that considerable efficiencies are produced in generating an animated graphic art presentation by generating a computer tomography scan of an object and using that scan as a basis to animate portions of a resultant rendering relative to the other portions. By way of example, a computer tomography scan of a fish rapidly provides a wire point structure inclusive of anatomical limitations from which animated motion of a fish occurs more rapidly than from conventional animation techniques. An additional example includes producing aliens or other fanciful creatures based on the animation of a data file associated with an embryonic creature or invertebrate.

An additional animation effect afforded by the present invention to provide a visual effect not previously available includes the morphing of a first object rendering into a second object rendering to provide two-dimensional or three-dimensional morphing effects. Morphing according to the present invention can occur for a three-dimensional matrix of points, whereas previous techniques have only involved surface point transformational morphing.

### REFERENCES

(1) Felci U, D'Affronto C, Fumagalli M, Gritti G, Sarti E. [Radiotherapy of soft tissue tumors]. Radiol Med (Torino) 1984;70(11):891-3.
(2) Delibasis K S, Matsopoulos G K, Mouravliansky N A, Nikita K S. A novel and efficient implementation of the marching cubes algorithm. Comput Med Imaging Graph 2001;25:343-52.
(3) Napel S, Marks M P, Rubin G D, et al. CT angiography with spiral CT and maximum intensity projection. Radiology 1992; 185:607-10.
(4) Levoy M. Display of Surfaces from Volume Data. IEEE Computer Graphics & Applications 1988;8(5):29-37.
(5) Möller T, Machiraju R, Mueller K, Yagel R. Evaluation and Design of Filters Using a Taylor Series Expansion. IEEE Transactions on Visualization and Computer Graphics 1997;3(2):184-99.
(6) Kindlmann G, Durkin J W. Semi-Automatic Generation of Transfer Functions for Direct Volume Rendering. In: IEEE Symposium On Volume Visualization; 1998. p. 79-86.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

The foregoing description is illustrative of particular embodiments of the invention, but is not meant to be a limitation upon the practice thereof. The following claims, including all equivalents thereof, are intended to define the scope of the invention.

1. A graphic arts image development process comprising:
generating a computer tomography scan of an object to yield a computer data file representative of a three-dimensional volume X-ray density of said object;
performing computer algorithms to said computer data file to yield an object rendering as a three-dimensional array of false colored pixels; and
applying a graphic arts technique to said rendering within a two-dimensional image space to yield a graphic arts image, said graphic arts technique selected from the group consisting of: duplication, symmetry inversion, contrast inversion, superposition of a second image, and distortion.

2. The process of claim 1 further comprising modifying a color of said rendering.

3. The process of claim 1 wherein said graphic arts technique is duplication to yield a second rendering image.

4. The process of claim 3 further comprising coloring said second rendering image relative to said rendering.

5. The process of claim 3 wherein said second rendering image overlies in part said rendering.

6. The process of claim 5 wherein said second rendering image overlies in part said rendering to yield a hologram or an anaglyph.

7. The process of claim 1 wherein said graphic arts technique is symmetry inversion to yield a symmetry invert image.

8. The process of claim 7 wherein said symmetry invert image is juxtaposed in opposition to said rendering.

9. The process of claim 1 wherein said graphic arts technique is distortion and a spacing between two adjacent pixels of said array of pixels is modified.

10. The process of claim 1 further comprising printing a plurality of copies of said graphic arts image.

11. The process of claim 10 wherein said plurality of copies is greater than 10,000.

12. The process of claim 1 further comprising:
associating a plurality of data points within said data file to yield a grouping movable relative to a plurality of remaining data points; and
animating a motion of said grouping.

13. The process of claim 12 wherein said animation is throughout the three-dimensional volume X-ray density of said object.

14. The process of claim 1 wherein said computer tomography scan of said object is collected as a function of time.

15. A graphic arts image development process comprising:
generating a computer tomography scan of an object to yield a computer data file representative of a three-dimensional volume X-ray density of said object;
performing computer algorithms to said computer data file to yield an object rendering as a three-dimensional array of pixels;
associating a plurality of data points within said data file to yield a grouping movable relative to a plurality of remaining data points; and
animating a motion of said grouping.

16. The process of claim 15 further comprising applying a modified surface texture or color to said grouping.

17. The process of claim 15 further comprising grouping said plurality of remaining data points to form a second group movable relative to said grouping.

18. The process of claim 15 further comprising morphing said object rendering into a second object rendering.

19. An animated graphic arts image comprising:
a first visual depiction in false color of data file corresponding to a first portion of an object as a first portion wire-frame shell and three-dimensional first portion volume, the volume having non-zero values; and
a second visual depiction in false color of data file corresponding to a second portion of an object as a second portion wire-frame shell and three-dimensional second portion volume, the volume having non-zero values, said second visual depiction moving as a function of time relative to said first visual depiction.
